(19) United States
(12) Patent Application Publication
(10) Pub. No.: US 2023/0284208 A1
(43) Pub. Date: Sep. 7, 2023

(54) PACKET PROCESSING APPARATUS AND PACKET PROCESSING METHOD

(71) Applicant: Fujitsu Limited, Kawasaki-shi (JP)

(72) Inventor: AKIHIRO HATA, Kawasaki (JP)

(73) Assignee: Fujitsu Limited, Kawasaki-shi (JP)

(21) Appl. No.: 18/067,909

(22) Filed: Dec. 19, 2022

(30) Foreign Application Priority Data
Mar. 4, 2022 (JP) 2022-033517

(51) Int. Cl. H04W 72/1263; H04W 72/566

(52) U.S. Cl. CPC H04W 72/1263; H04W 72/566

(57) ABSTRACT

A packet processing apparatus includes: a gate provided for each service and configured to open and close an output of a packet in a unit of a time slot; and a processor configured to: decide open/close information of a corresponding gate in a first time slot at a current time point by using a set operation parameter; control opening and closing of each gate based on the open/close information in the first time slot; decide open/close information of the corresponding gate in a second time slot after a predetermined timing from the current time point by using the operation parameter; detect a timing conflict between the services in the open/close information in the second time slot; change contents of the operation parameter set based on a priority order; reset the changed operation parameter; and decide open/close information in a new first time slot by using the set changed operation parameter.

### CROSS-REFERENCE TO RELATED APPLICATION

This application is based upon and claims the benefit of priority of the prior Japanese Patent Application No. 2022-33517, filed on Mar. 4, 2022, the entire contents of which are incorporated herein by reference.

### FIELD

The embodiment discussed herein is related to a packet processing apparatus and a packet processing method.

### BACKGROUND

For achieving the fifth generation mobile communication system (5G), a centralized radio access network (C-RAN) that is configured with a baseband unit (BBU) and a remote radio head (RRH) or a centralized unit (CU), a distributed unit (DU), and a radio unit (RU) have been studied in recent years. As for a mobile front haul (MFH) line between the DU and the RU, there has been studied an adoption of an enhanced common public radio interface (eCPRI) method for transmitting radio signals in a state of being stored in an ether frame.

Japanese Laid-open Patent Publication Nos. 2019-176276 and 2015-99951 are disclosed as related art.

### SUMMARY

According to an aspect of the embodiments, a packet processing apparatus includes: a gate provided for each service and configured to open and close an output of a packet in a unit of a time slot; and a processor coupled to the gate and configured to: decide open/close information of a corresponding gate in a first time slot at a current time point by using a set operation parameter, for each reception timing of the time slot, for each of the services; control opening and closing of each gate based on the open/close information in the first time slot at the current time point for each of the services; decide open/close information of the corresponding gate in a second time slot after a predetermined timing from the current time point by using the operation parameter for each of the reception timings, for each of the services; detect a timing conflict between the services in the open/close information in the second time slot after the predetermined timing for each of the services; in a case where the timing conflict is detected, change contents of the operation parameter set to avoid the timing conflict between the services based on a priority order for each of the services; reset the changed operation parameter before the predetermined timing arrives; and decide open/close information in a new first time slot at the current time point by using the set changed operation parameter for each of the reception timings after the changed operation parameter is set, for each of the services.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a communication system;

FIG. 2 is an explanatory diagram illustrating an example of a hardware configuration of an iTAS apparatus;

FIG. 3 is an explanatory diagram illustrating an example of a functional configuration of a control unit in a packet processor;

FIG. 4 is an explanatory diagram illustrating an example of a processing operation of the packet processor related to open/close determination processing;

FIG. 5 is an explanatory diagram illustrating an example of a processing operation of a packet processor related to open/close prediction processing;

FIG. 6 is an explanatory diagram illustrating an example of a processing operation of a packet processor related to arbitration processing;

FIG. 7 is an explanatory diagram illustrating an example of a transfer timing of arbitration information;

FIGS. 8A and 8B are a flowchart illustrating an example of a processing operation of a first decision unit related to the open/close determination processing;

FIGS. 9A and 9B are a flowchart illustrating an example of a processing operation of a second decision unit related to the open/close prediction processing;

FIG. 10 is a flowchart illustrating an example of a processing operation of an arbitration unit related to the arbitration processing;

FIG. 11 is an explanatory diagram illustrating an example of a processing operation of the communication system related to the arbitration processing;

FIG. 12 is an explanatory diagram illustrating an example of a hardware configuration of an iTAS apparatus according to a comparative example;

FIG. 13 is an explanatory diagram illustrating an example of a GCL used in an iTAS apparatus according to the comparative example;

FIG. 14 is an explanatory diagram illustrating an example of an update operation of the GCL at the time of a timing conflict between classes in the comparative example;

FIG. 15 is an explanatory diagram illustrating an example of a problem of a conflict timing between services in the comparative example; and

FIG. 16 is an explanatory diagram illustrating an example of a problem of the conflict timing between the services in the comparative example.

### DESCRIPTION OF EMBODIMENTS

In a communication system coupled to an MFH line, information is handled as layer 2 packets, and therefore, the network may be shared with a mobile back haul (MBH) line coupling base stations, a wired network, or the like. For example, since an output delay occurs because a timing conflict occurs between an MFH packet from the MFH line and another packet, for example, an MBH packet from an MBH line in a communication system, priority control processing for suppressing the output delay is known. In the priority control processing, a subsequent high-priority packet is preferentially read before a queued low-priority packet, and thus an output delay of the high-priority packet, for example, the MFH packet may be suppressed.

However, in the priority control processing, when a high-priority packet arrives during reading of a low-priority packet, the reading operation of the high-priority packet is stopped until the read and output of the low-priority packet being read are completed. As a result, there occurs wait for up to about one packet. When a link rate is 1 Gbps and a packet length is 9000 bytes, for example, an output delay of about 7μ seconds occurs. Since an output delay of 100μ seconds or less is demanded between the RU and the DU in the MFH line, this output delay for one packet is not ignorable in a case of a multistage node configuration.

Institute of Electrical and Electronics Engineers (IEEE) 802.1 time sensitive networking (TSN) has been studied as another method for suppressing the output delay. The TSN includes a time aware shaper (TAS) method of the IEEE802.1Qbv as a data plane function to suppress the output delay of the packet.

A TAS apparatus that is a packet processing apparatus adopting a TAS technique opens and closes each gate based on a gate control list (GCL) for controlling opening and closing of a gate provided for each type of a received packet. Each gate has a gate for opening and closing an output of the MFH packet and a gate for opening and closing an output of the MBH packet. The GCL manages open/close information for controlling the opening and closing of each gate for each time slot (TS) by using a traffic pattern of the MFH packet. By referring to the GCL and controlling opening and closing of each gate for each TS, the TAS apparatus may preferentially output the MFH packet.

In order to achieve very sensitive gate opening and closing setting in an order of microseconds in the TAS apparatus, a mechanism for maintaining the setting is demanded. Accordingly, the TAS apparatus acquires timings of the MFH packet and the MBH packet, and autonomously learns a transfer period, a phase, or the like of these packets. An intelligent TAS (iTAS) technique is employed in which the TAS apparatus corrects table contents of the GCL that manages the MFH packet or an output timing of the MFH packet based on the contents obtained by autonomous learning.

However, among MFH packets of the same type, there are services such as a plurality of types of classes having different delay requests, bandwidths, or transfer periods. Examples of the service of the MFH packet include MFH packets of a user terminal having different delay requests, bandwidths, or transfer periods, and MFH packets of each class having different delay requests, bandwidths, or transfer periods. Accordingly, in an iTAS apparatus that is a packet processing apparatus adopting the iTAS technique, a timing conflict between different services in the MFH packets of the same type is also assumed. Accordingly, there is a demand for an iTAS apparatus capable of avoiding a timing conflict between different services in the MFH packets of the same type.

According to one aspect, there is provided a packet processing apparatus and the like capable of avoiding a timing conflict between different services in the packets of the same type.

A communication system according to a comparative example has a plurality of iTAS apparatuses that perform switching and outputting an MBH packet from an MBH line and an MFH packet from an MFH line. Each iTAS apparatus may avoid not only preferential output of the MFH packet but also a timing conflict between different services in the MFH packets of the same type.

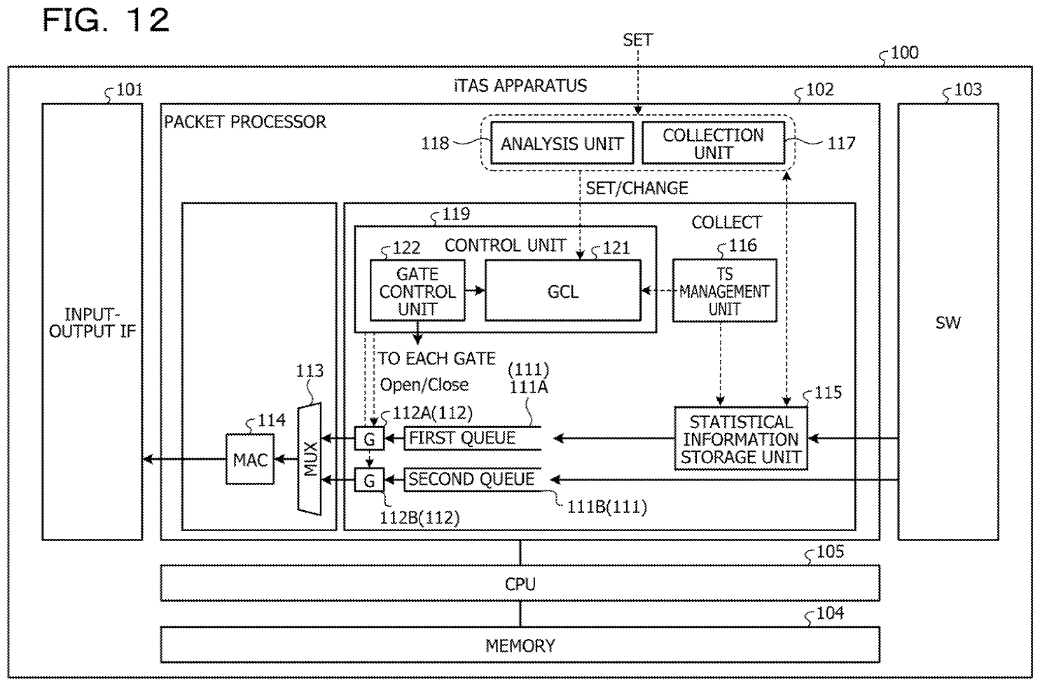

FIG. 12 is an explanatory diagram illustrating an example of a hardware configuration of an iTAS apparatus 100 according to the comparative example. The iTAS apparatus 100 illustrated in FIG. 12 has an input-output interface (IF) 101, a plurality of packet processors 102, a switch (SW) 103, a memory 104, and a central processing unit (CPU) 105. The input-output IF 101 is an IF that is coupled to various lines such as the MBH line and the MFH line and inputs and outputs packets. For example, the input-output IF 101 is coupled to an RU, a DU, and the other iTAS apparatuses 100. The packet processor 102 executes packet processing to which an iTAS method is applied. The SW 103 is a switch for switching between input and output of the packet processor 102. The memory 104 is a region for storing various information. The CPU 105 controls the entire iTAS apparatus 100.

For each class of MFH packets of the same type, the packet processor 102 controls an output timing of the MFH packet of each class, as well as preferential output of the MFH packet. The packet processor 102 has a plurality of queues 111, a plurality of gates 112, a multiplexer (MUX) 113, a media access control (MAC) 114, a statistical information storage unit 115, a TS management unit 116, a collection unit 117, an analysis unit 118, and a control unit 119.

Each queue 111 is a storage unit that is provided for each type of incoming received packet and queues the received packet for each type. The type of received packet has, for example, an MFH packet and an MBH packet. The MFH packet is a high-priority packet, whereas the MBH packet is a low-priority packet having a lower priority than the MFH packet. For example, the MFH packet has a plurality of types of packets of different classes C0 to C7. Each class is, for example, a service that desires low latency and has a different bandwidth or transfer period.

A first queue 111A among the plurality of queues 111 is a storage unit that queues the MBH packet, among incoming received packets. A second queue 111B among the plurality of queues 111 is a storage unit that queues, for example, an MFH packet of the class C0, among the MFH packets of the incoming received packets. A third queue 111C (not illustrated) among the plurality of queues 111 is a storage unit that queues, for example, an MFH packet of the class C1, among the MFH packets of the incoming received packets. A fourth queue 111D (not illustrated) among the plurality of queues 111 is a storage unit that queues, for example, an MFH packet of the class C2, among the MFH packets of the incoming received packets. For example, it is assumed that the queue 111 is provided for each class of the MFH packet.

The SW 103 identifies a P bit of a virtual local area network (VLAN) tag in the received packet, and transfers the corresponding type of received packet to the queue 111 corresponding to the type of the received packet based on the identification result.

Each gate 112 is provided for each queue 111, and opens and closes an output of the received packet stored in the queue 111 in a unit of TS. Among the plurality of gates 112, a first gate 112A opens and closes an output of the MBH packet in the first queue 111A in a unit of TS. Among the plurality of gates 112, a second gate 112B opens and closes an output of the MFH packet of the class C0 in the second queue 111B in a unit of TS. Among the plurality of gates 112, a third gate 112C (not illustrated) opens and closes an output of the MFH packet of the class C1 in the third queue 111C in a unit of TS. Among the plurality of gates 112, a fourth gate 112D (not illustrated) opens and closes an output of the MFH packet of the class C3 in the fourth queue 111D in a unit of TS. For example, it is assumed that the gate 112 is provided for each class of the MFH packet.

The MUX 113 selects and outputs an output packet of each gate 112. The MAC 114 adds a MAC address to the output packet of the MUX 113, and outputs the output packet with the added MAC address to the input-output IF 101. The statistical information storage unit 115 is a region for storing a period pattern of the received packets as statistical information. The TS management unit 116 is a counter that counts a current time slot (TS).

The collection unit 117 collects the statistical information on the received packets. The statistical information is an amount of received packets for each time slot. The amount of packets is, for example, the number of packets or the number of bytes. The analysis unit 118 analyzes the statistical information on the received packets to specify a periodicity of the received packets and a periodicity pattern such as a pattern. The analysis unit 118 learns an arrival interval (periodicity) and a pattern (average arrival amount and burst fluctuation degree) of the received packets.

The control unit 119 controls the entire packet processor 102. The control unit 119 has a GCL 121 and a gate control unit 122. The GCL 121 is a table for managing open/close information of the gate 112 in a unit of TS number for each received packet. The received packets are the MBH packets and the MFH packets of classes C0 to C1. Based on the analysis result of the analysis unit 118, the control unit 119 updates table contents of the GCL 121. Based on the periodicity pattern of the received packet, the control unit 119 updates the TS number in the GCL 121 and a residence time for each TS number. Further, the control unit 119 updates the open/close information for each TS number of each gate 112 in the GCL 121 based on the periodicity pattern. Based on the statistical information of each class of the MFH packets in the received packets, the control unit 119 predicts an arrival timing of each class of the MFH packets that are high-priority packets. The open/close information is a setting state of each gate 112, for example, open and close. Based on the table contents of the GCL 121, the gate control unit 122 controls opening and closing of each gate 112 in a unit of TS.

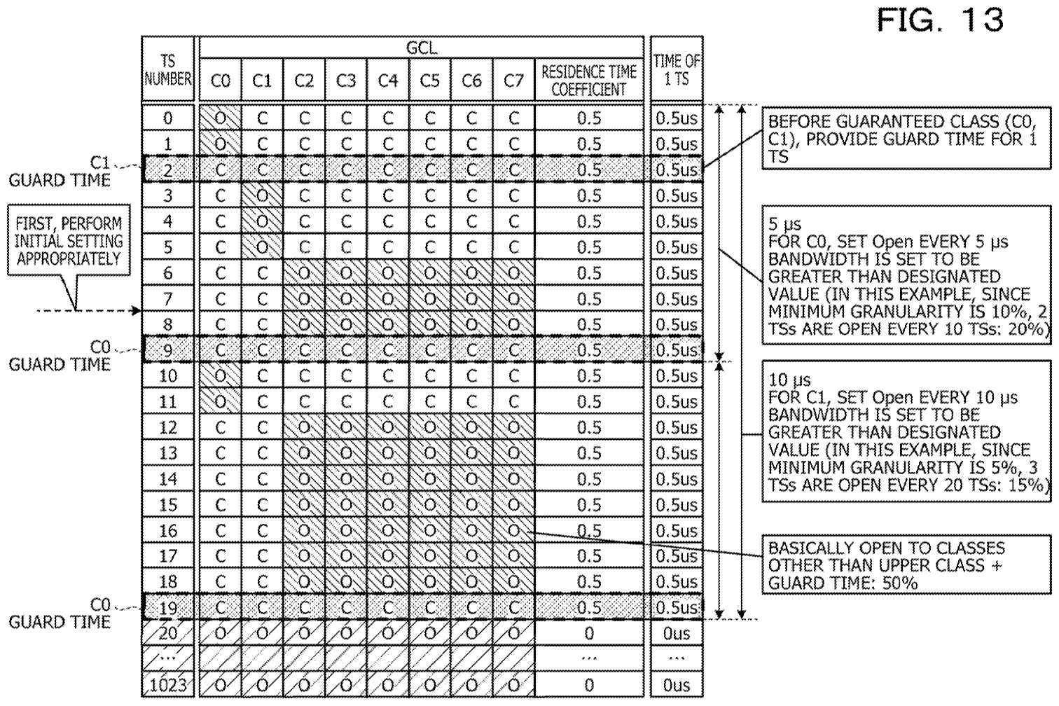

FIG. 13 is an explanatory diagram illustrating an example of the GCL 121 used in the iTAS apparatus 100 according to the comparative example. The GCL 121 illustrated in FIG. 13 manages a TS number, open/close information of each of the classes C0 to C1, and a residence time in association with each other. For convenience of description, it is assumed that, as the open/close information in the GCL 121, not only the open/close information of the MFH packet in units of the classes C0 to C1 but also the open/close information of the MBH packet are managed.

The TS number is a number for identifying a TS of a received packet. The open/close information of each of the classes C0 to C1 is open/close information indicative of an open (0)/close (C) state of the gate 112 corresponding to each class of the MFH packet. The residence time is an allocation time of the TS number. The TS number may be changed as appropriate in a range from 1 to N. The open/close information of each of the classes C0 to C1 may also be changed as appropriate for each TS number. Also, the residence time may be changed as appropriate for each TS number. By referring to the GCL 121, the gate control unit 122 sets the open/close information of each class corresponding to the TS number “1” in each gate 112 at a timing of the TS number “1”. Next, the gate control unit 122 sets the open/close information of each class corresponding to the TS number “2” in each gate 112 at a timing of the TS number “2”. Further, the gate control unit 122 sequentially sets the open/close information of each class in each gate 112 at each timing from the TS number “3” to the TS number “N”. After setting the open/close information corresponding to the TS number “N”, the gate control unit 122 returns to the TS number “1” again, sets the open/close information corresponding to the TS number “1”, and sequentially sets the open/close information at each timing from the TS number “2” to the TS number “N”. For example, the gate control unit 122 refers to the GCL 121, and periodically and repeatedly sets each open/close information in each gate 112 at each timing from the TS number “1” to the TS number “N”.

For the MFH packet of the class C0 illustrated in FIG. 13, since open is set every 5μ seconds, the transfer period is 5μ seconds, and since a minimum granularity is 10% and 2 TSs are open every 10 TSs, a bandwidth is 20%. For the MFH packet of the class C1, since open is set every 10μ seconds, the transfer period is 10μ seconds, and since the minimum granularity is 5% and 3 TSs are open every 20 TSs, a bandwidth is 15%. A guard time for 1 TS is provided immediately before the class C0 and the class C1. For the guard time and the TS number other than the upper class C0 (C1), open is set in each gate 112 of the classes C2 to C7. Although the setting state of the MBH packet is not clearly described for convenience of description, it is assumed that open is set in the gate 112 of the MBH packet for the guard time and the TS number other than the classes C0 to C7, for example.

For example, in the iTAS apparatus 100, it is possible to avoid the timing conflict of each of the different classes C0 to C7 in the same MFH packet by referring to the GCL 121 that manages the open/close information of each gate 112 of each of the different classes C0 to C7 in the MFH packet for each TS number.

In a case where the timing conflict of each class in the same MFH packet occurs in the iTAS apparatus 100, the open/close information of each class at the conflict timing is changed, and the contents of the GCL 121 are updated to update the changed open/close information of each class.

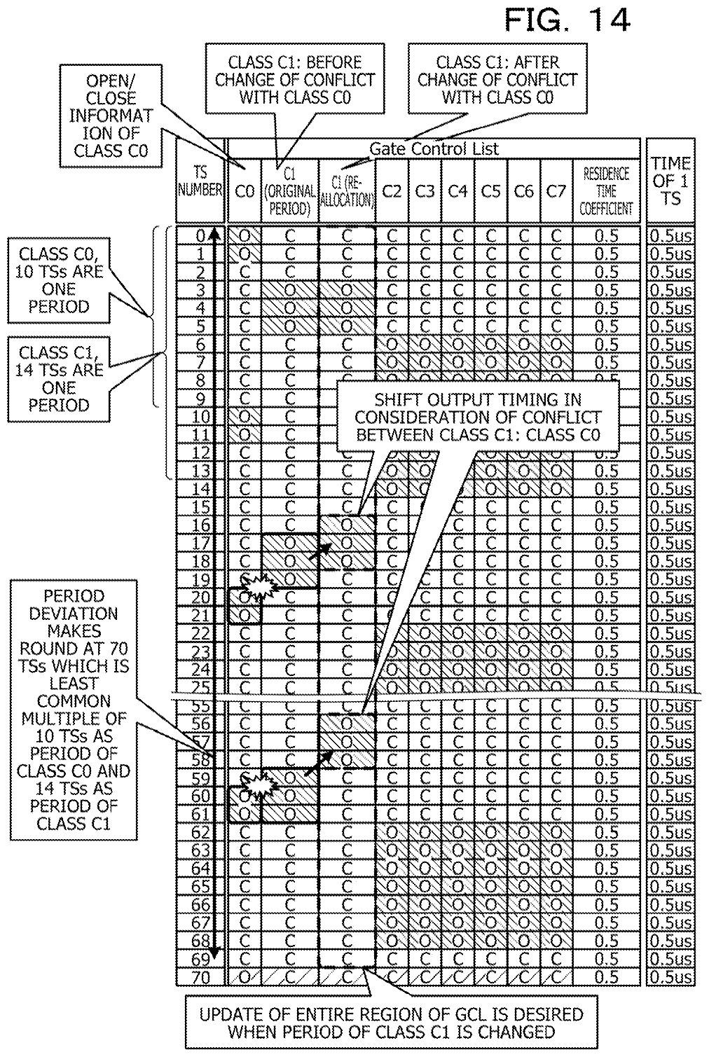

FIG. 14 is an explanatory diagram illustrating an example of an update operation of the GCL 121 at the time of the timing conflict between classes in the comparative example. For example, it is assumed that the transfer period of the MFH packet of the class C0 is 5μ seconds, the bandwidth is 20%, and 10 TSs are one period. The transfer period of the MFH packet of the class C1 is 7μ seconds, the bandwidth is 15%, and 14 TSs are one period. TSs other than the guard time TS and the open TS of the class C0 (C1) are allocated to the MBH packet and the other classes C2 to C7. In this case, a period deviation makes a round at 70 TSs, which is the least common multiple of 10 TSs as the period of the class C0 and 14 TSs as the period of the class C1.

In the iTAS apparatus 100, in order to manage the open/close information for each of the classes having different transfer periods, a table capacity of the GCL 121 for managing the open/close information for 70 TSs as the least common multiple is desired. For example, when the timings of the class C0 and the class C1 conflict with each other in the iTAS apparatus 100, the timing of the class C1 in the GCL 121 of 70 TSs as the least common multiple is changed, and the open/close information from the TS number 0 to the TS number 69 of the changed class C1 is corrected.

For example, in the iTAS apparatus 100 of the comparative example, in order to avoid the timing conflict between the classes, a large-capacity GCL 121 for TSs as the least common multiple of the transfer periods of the respective classes, which is a combination of all the patterns of the conflict timing between the classes, is desired. Furthermore, in the iTAS apparatus 100, when the table contents of the GCL 121 are corrected, a large amount of processing time is desired for correction processing of the table contents of the large-capacity GCL 121.

As the correction processing of the table contents of the GCL 121, for example, in a case where the TS number is 1 to 2048, the class C0 and the class C1 conflict with each other in terms of timing, and open of the class C1 is shifted by 1 TS, all bits (2048 bits) of the class C1 are to be corrected. In this case, in order to correct a region for 2048 bits in the GCL 121, it takes a large amount of processing time to access the GCL 121 a plurality of times and correct the contents of the class C1 for 2048 bits.

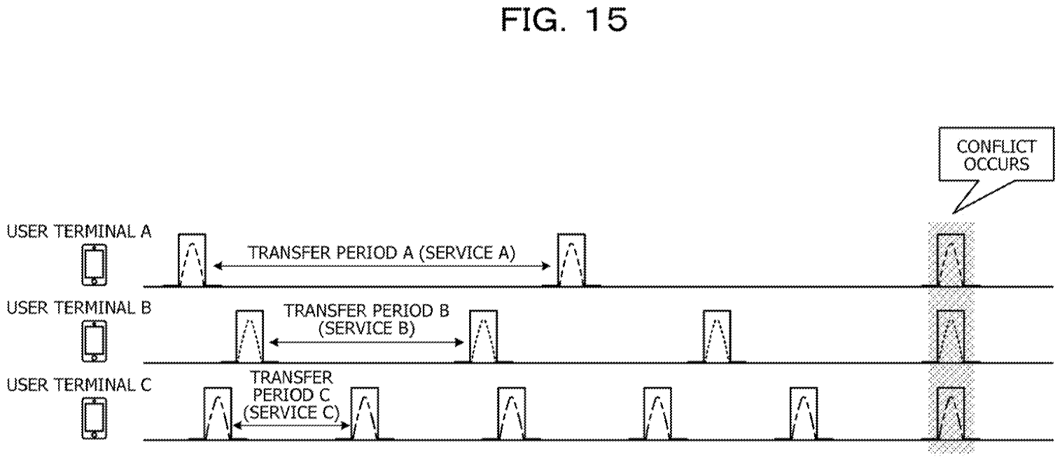

Furthermore, each iTAS apparatus 100 in the communication system is not limited to the class of the MFH packet, and it is also assumed that each user terminal outputs the MFH packet at different transfer periods. FIG. 15 is an explanatory diagram illustrating an example of a problem of a conflict timing between services in the comparative example. For example, there is a case where a transfer period of an MFH packet of a service A of a user terminal A, a transfer period of an MFH packet of a service B of a user terminal B, and a transfer period of an MFH packet of a service C of a user terminal C conflict with each other.

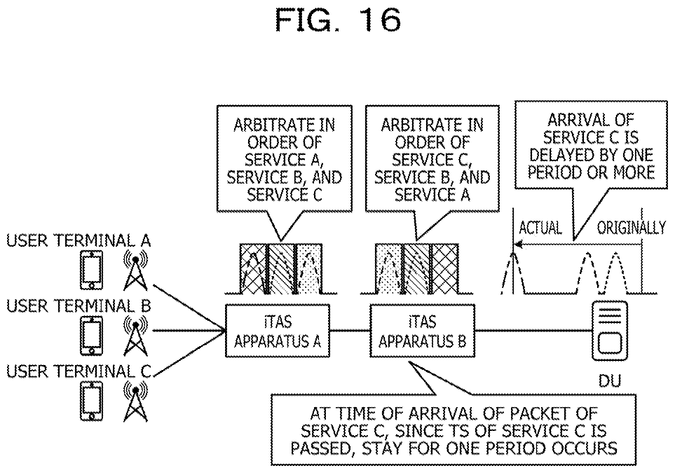

FIG. 16 is an explanatory diagram illustrating an example of a problem of the conflict timing between the services in the comparative example. There is a case where each iTAS apparatus 100 in the communication system has different table contents in the GCL 121. For example, it is assumed that the GCL 121 of the iTAS apparatus 100 of “A” manages open/close information in which the MFH packet of the service A, the MFH packet of the service B, and the MFH packet of the service C are output in this order at a predetermined timing. On the other hand, for example, it is assumed that the GCL 121 of the iTAS apparatus 100 of “B” manages open/close information in which the MFH packet of the service C, the MFH packet of the service B, and the MFH packet of the service A are output in this order at a predetermined timing. In this case, the iTAS apparatus 100 of “A” refers to the GCL 121 and outputs the MFH packet of the service A, the MFH packet of the service B, and the MFH packet of the service C to the iTAS apparatus 100 of “B” in this order. The iTAS apparatus 100 of “B” receives the MFH packet of the service A, the MFH packet of the service B, and the MFH packet of the service C in this order. However, the iTAS apparatus 100 of “B” refers to the GCL 121 and outputs the MFH packet of the service C, the MFH packet of the service B, and the MFH packet of the service A in this order. At the time of arrival of the MFH packet of the service C, the iTAS apparatus 100 of “B” stays for one period because the output timing of the MFH packet of the service C is passed, and an output delay of the MFH packet of the service C occurs.

As a result, in a case where the table contents in the GCL 121 of each iTAS apparatus 100 over a communication path are different, an output delay of the MFH packet of each service occurs, and a delay variation of each of services having different MFH packet transfer periods increases.

Accordingly, there is a demand for an iTAS apparatus capable of avoiding the timing conflict between the services in the MFH packets of the same type while suppressing the output delay of the MFH packet without using the GCL 121. An embodiment of the packet processing apparatus such as the iTAS apparatus will be described below as an example.

### Embodiment

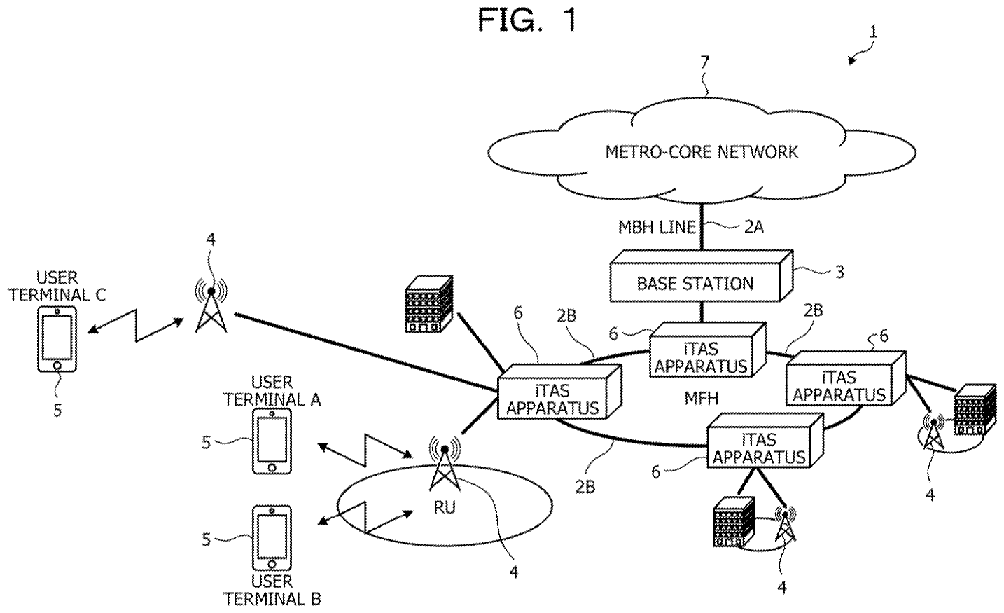

FIG. 1 is an explanatory diagram illustrating an example of a communication system 1 of Embodiment 1. The communication system 1 illustrated in FIG. 1 has an MBH line 2A, an MFH line 2B, a base station 3, an RU 4, a user terminal 5, and an iTAS apparatus 6. The MBH line 2A is a line for coupling between a plurality of base stations (evolved Node B (eNB)) 3 or between the base station 3 and a metro-core network 7. For example, the MFH line 2B is a line that couples the RU 4 and the DU in the base station 3. The RU 4 is wirelessly coupled to the user terminal 5. The MFH line 2B employs the eCPRI method in which radio signals are transmitted between the RU 4 and the DU using the MFH packet in the L2 frame. The iTAS apparatus 6 transmits various packets such as an MBH packet from the MBH line 2A and an MFH packet from the MFH line 2B. The MFH packets are strongly demanded to suppress an output delay compared to the MBH packets. Furthermore, the MFH packets have different packets for each class.

The DU has a function of scheduling a radio section. The scheduling function is a function to decide various elements such as user data, a code rate, and a modulation method, for example, to be transmitted to one subframe. The DU divides the user data into the L2 frames and transmits the MFH packet to the RU 4. For example, the DU transmits the MFH packets to the RU 4 at subframe intervals, for example, every 1 m second. The RU 4 divides the user data of the received radio signals into the L2 frames and transmits the MFH packets to the DU.

The iTAS apparatus 6 transmits various packets in addition to the MBH packet and the MFH packet. The iTAS apparatus 6 applies a time aware shaper (TAS) method of IEEE802.1Qbv, and outputs the MFH packet as the high-priority packet. Further, the iTAS apparatus 6 has a function of not only preferentially outputting an MFH packet but also avoiding timing conflict between different services (classes) in the MFH packets of the same type.

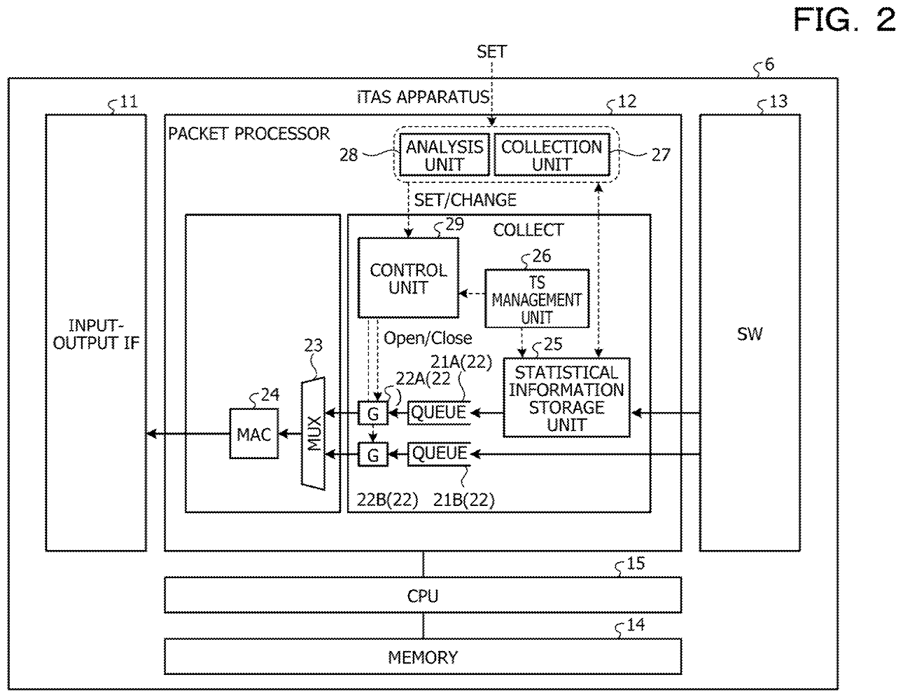

FIG. 2 is an explanatory diagram illustrating an example of a hardware configuration of the iTAS apparatus 6. The iTAS apparatus 6 illustrated in FIG. 2 has an input-output interface (IF) 11, a plurality of packet processors 12, a switch (SW) 13, a memory 14, and a central processing unit (CPU) 15. The input-output IF 11 is an IF that is coupled to various lines such as the MBH line 2A and the MFH line 2B and inputs and outputs a packet. For example, the input-output IF 11 is coupled to the RU 4, the DU, and the other iTAS apparatuses 6. The packet processor 12 executes packet processing to which the iTAS method is applied. The SW 13 is a switch for switching between input and output of the packet processor 12. The memory 14 is a region for storing various information. The CPU 15 controls the entire iTAS apparatus 6.

For each class of the MFH packets of the same type, the packet processor 12 controls the output timing of the MFH packet of each class, as well as the output timings of the MBH packet and the MFH packet, and the preferential output of the MFH packet. The packet processors 12 has a plurality of queues 21, a plurality of gates 22, a multiplexer (MUX) 23, an MAC 24, a statistical information storage unit 25, a TS management unit 26, a collection unit 27, an analysis unit 28, and a control unit 29.

Each queue 21 is a storage unit that is provided for each type of incoming received packet and queues the received packet for each type. The type of received packet has, for example, the MFH packet and the MBH packet. The MFH packet is a high-priority packet, whereas the MBH packet is a low-priority packet having a lower priority than the MFH packet. For example, the MFH packet has a plurality of types of packets of different classes C0 to C7. Each class is, for example, a service that desires low latency and has a different bandwidth or transfer period.

A first queue 21A among the plurality of queues 21 is a storage unit that queues the MBH packet, among incoming received packets. A second queue 21B among the plurality of queues 21 is a storage unit that queues, for example, an MFH packet of the class C0, among the MFH packets of the incoming received packets. A third queue 21C (not illustrated) among the plurality of queues 21 is a storage unit that queues, for example, an MFH packet of the class C1, among the MFH packets of the incoming received packets. A fourth queue 21D (not illustrated) among the plurality of queues 21 is a storage unit that queues, for example, an MFH packet of the class C2, among the MFH packets of the incoming received packets. For example, it is assumed that the queue 21 is provided for each class of the MFH packet.

The SW 13 identifies a P bit of a VLAN tag in the received packet, and transfers the corresponding type of the received packet to the queue 21 corresponding to the type of the received packet based on the identification result.

Each gate 22 is provided for each queue 21, and opens and closes an output of the received packet stored in the queue 21 in a unit of TS. For example, 1 TS is 0.5μ seconds. Among the plurality of gates 22, a first gate 22A opens and closes the output of the MBH packet in the first queue 21A in a unit of TS. Among the plurality of gates 22, a second gate 22B opens and closes an output of the MFH packet of the class C0 in the second queue 21B in a unit of TS. Among the plurality of gates 22, a third gate 22C (not illustrated) opens and closes an output of the MFH packet of the class C1 in the third queue 21C in a unit of TS. Among the plurality of gates 22, a fourth gate 22D opens and closes an output of the MFH packet of the class C3 in the fourth queue 21D in a unit of TS. For example, it is assumed that the gate 22 is provided for each class of the MFH packet.

The MUX 23 selects and outputs an output packet of each gate 22. The MAC 24 adds a MAC address to an output packet of the MUX 23, and outputs the output packet with the added MAC address to the input-output IF 11. The statistical information storage unit 25 is a region for storing a period pattern of the received packets as statistical information. The TS management unit 26 has a time counter 16A that counts a current counter value in a unit of TS.

The collection unit 27 collects the statistical information on the received packets. The statistical information is an amount of received packets for each time slot. The amount of packets is, for example, the number of packets or the number of bytes. The analysis unit 28 analyzes the statistical information on the received packets to specify a periodicity of the received packets and a periodicity pattern such as a pattern. The analysis unit 28 learns an arrival interval (periodicity) and a pattern (average arrival amount and burst fluctuation degree) of the received packets. Based on the period pattern of the MFH packet of each class, the analysis unit 28 acquires an operation parameter that is a variable for each class. The operation parameter has the number of transfer period TSs, the number of open TSs, the number of guard time TSs, and the number of transfer period offset TSs.

The number of transfer period TSs is the number of TSs for the transfer period of the MFH packet for each class. The number of guard time TSs is the number of TSs of the guard time for each class, among the number of transfer period TSs. Among the number of transfer period TSs, the number of open TSs is the number of TSs in which the gate 22 for each class is opened. The number of transfer period offset TSs is the number of TSs at which output of the MFH packet is started for each class, among the number of transfer period TSs.

The control unit 29 controls the entire packet processor 12. Based on the analysis result of the analysis unit 28, the control unit 29 acquires the operation parameter such as the number of transfer period TSs of the MFH packet of each class as well as the MBH packet.

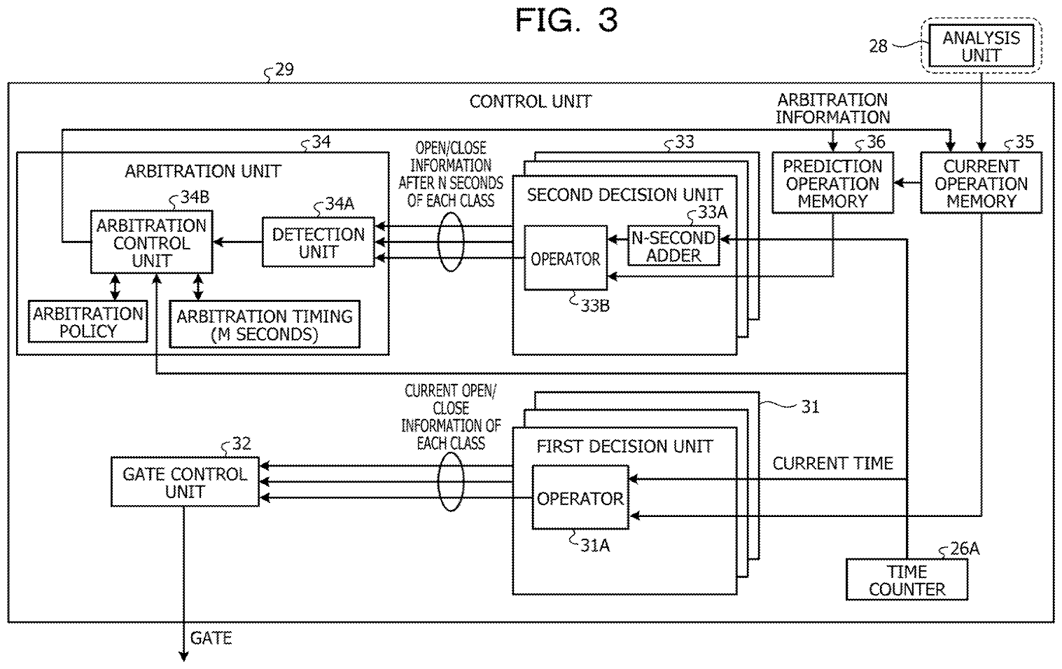

FIG. 3 is a block diagram illustrating an example of a functional configuration of the control unit 29 in the packet processor 12. The control unit 29 illustrated in FIG. 3 has a plurality of first decision units 31, a gate control unit 32, a plurality of second decision units 33, an arbitration unit 34, a current operation memory 35, and a prediction operation memory 36. The analysis unit 28 stores the acquired operation parameter for each class in the current operation memory 35.

The first decision unit 31 is provided for each class of the MFH packet and has an operator 31A that calculates open/close information of the gate 22 corresponding to the class in the current TS by using a current operation parameter and a current counter value corresponding to the class. When a TS pulse is received, the first decision unit 31 decides the open/close information of the gate 22 in the current TS which is a first time slot at the current time point, based on the calculation result of the operator 31A. The TS pulse is a pulse for counting a counter value in a unit of TS, and is a reception timing of the TS. The open/close information of the current TS is, for example, open, close, or guard time, which is a determination result of the gate 22 of the same class. The first decision unit 31 reads the operation parameter of the corresponding class from the current operation memory 35, and calculates and decides open/close information in the current TS by using the read operation parameter and the current counter value from a time counter 26A. Based on the open/close information of the current TS for each class, the gate control unit 32 controls the opening and closing of the gate 22 corresponding to the first decision unit 31.

The second decision unit 33 is provided for each class of the MFH packet and has an N-second adder 33A and an operator 33B for calculating open/close information in a predicted TS, which is a TS after N seconds, using the current operation parameter according to the class and (current counter value+predetermined time (N seconds)). The N-second adder 33A adds N seconds to the current counter value from the time counter 26A. The operator 33B calculates the open/close information in the predicted TS by using (current counter value+N seconds) and the current operation parameter. Based on the calculation result of the operator 33B, the second decision unit 33 decides the open/close information of the gate 22 in the predicted TS, which is a second time slot after a predetermined timing from the current time point.

The arbitration unit 34 has a detection unit 34A that detects a timing conflict between the classes in the open/close information of the predicted TS after N seconds for each class. Further, the arbitration unit 34 has an arbitration control unit 34B that changes, in a case where the timing conflict between the classes in the predicted TS is detected, contents of the operation parameter for avoiding the timing conflict between the classes based on an arbitration policy such as a priority order for each conflicting class. Further, the arbitration control unit 34B calculates a reflection time M based on (N−M<shortest transfer period). The reflection time may be a time in consideration of a time until the changed operation parameter is updated to the current operation memory 35 within the shortest transfer period of the predicted conflict timing, and is, for example, N−M<the shortest transfer period.

The arbitration control unit 34B updates the changed operation parameter and the reflection time in the prediction operation memory 36. For example, the prediction operation memory 36 is a first in first out (FIFO) memory. Before the predetermined timing arrives, for example, when the current counter value is the reflection time, the arbitration control unit 34B updates the changed operation parameter stored in the prediction operation memory 36 in the current operation memory 35 as arbitration information. By using the changed operation parameter updated in the current operation memory 35, the arbitration control unit 34B causes the first decision unit 31 to decide the open/close information of the current TS, which is a new first time slot at the current time point, for each reception timing of the TS pulse at the reflection time and after the reflection time.

Usually, the contents of the operation parameters stored in the current operation memory 35 and the prediction operation memory 36 may be the same. Although the changed operation parameter is updated in the prediction operation memory 36 when the reflection of the changed operation parameter at the time of avoiding the conflict is scheduled, the contents of the operation parameters stored in the prediction operation memory 36 and the current operation memory 35 before the reflection time are different from each other.

The first decision unit 31 calculates and decides open/close information of the corresponding gate 22 in the current TS by using the current counter value from the time counter 26A in the TS management unit 26 and the current operation parameter including a period for observing the MFH packet of the class related to the corresponding first decision unit 31.

The second decision unit 33 adds N seconds to the current counter value from the time counter 26A. The second decision unit 33 calculates and decides open/close information of the corresponding gate 22 in a predicted TS after N seconds from the current time by using the current counter value after adding N seconds and an operation parameter including a period for observing the MFH packet of the class related to the corresponding second decision unit 33. The predetermined time N seconds may be a time in which the timing conflict between the classes is detected by the detection unit 34A from the current TS and the timing conflict is sufficiently avoided by the arbitration control unit 34B, and is, for example, N seconds>10 TSs.

The arbitration control unit 34B changes the number of transfer period offset TSs in the operation parameter to avoid the timing conflict between the classes. The arbitration control unit 34B updates the operation parameter including the changed number of transfer period offset TSs and the reflection time in the prediction operation memory 36. When the current counter value is the reflection time, the arbitration control unit 34B updates the operation parameter including the changed number of transfer period offset TSs in the current operation memory 35. At the reception timing of the TS pulse at the reflection time and after the reflection time, the first decision unit 31 calculates the open/close information in a new current TS for each class by using the changed current operation parameter for each class stored in the current operation memory 35. As a result, the gate control unit 32 may avoid the timing conflict between the classes predicted in the future based on the open/close information in the new current TS for each class.

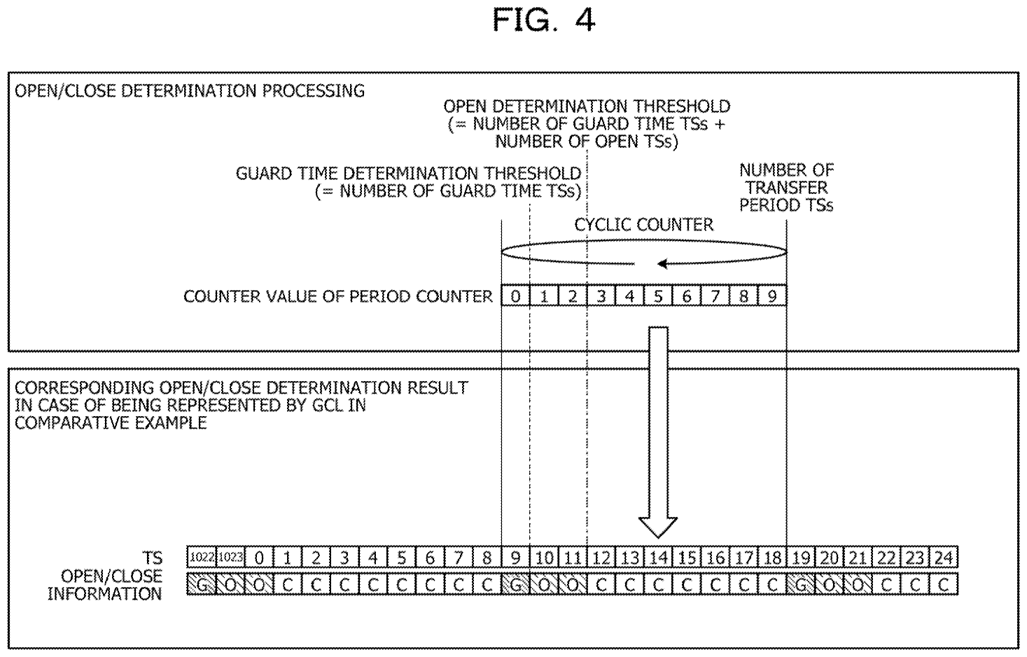

FIG. 4 is an explanatory diagram illustrating an example of a processing operation of the packet processor 12 related to open/close determination processing. Based on the number of transfer period TSs, the number of guard time TSs, the number of open TSs, and the number of transfer period offset TSs of the corresponding class, the first decision unit 31 calculates and decides the open/close information of the gate 22 corresponding to the corresponding class in the current TS from the current counter value counted.

The first decision unit 31 reads the number of transfer period TSs in the operation parameter stored in the current operation memory 35 as an initial value, and counts up a current counter value for each TS pulse from the time counter 26A. The number of current TSs, which is the current counter value, is circulated once in the number of transfer period TSs.

When the number of current TSs≤the number of guard time TSs, the first decision unit 31 determines the gate determination result of the current TS as the guard time. When the number of guard time TSs<the number of current TSs≤(the number of guard time TSs+the number of open TSs), the first decision unit 31 determines that the gate determination result of the current TS is open. When (the number of guard time TSs+the number of open TSs)<the number of current TSs, the first decision unit 31 determines that the gate determination result of the current TS is close. Each first decision unit 31 determines the open/close information of the current TS of each class.

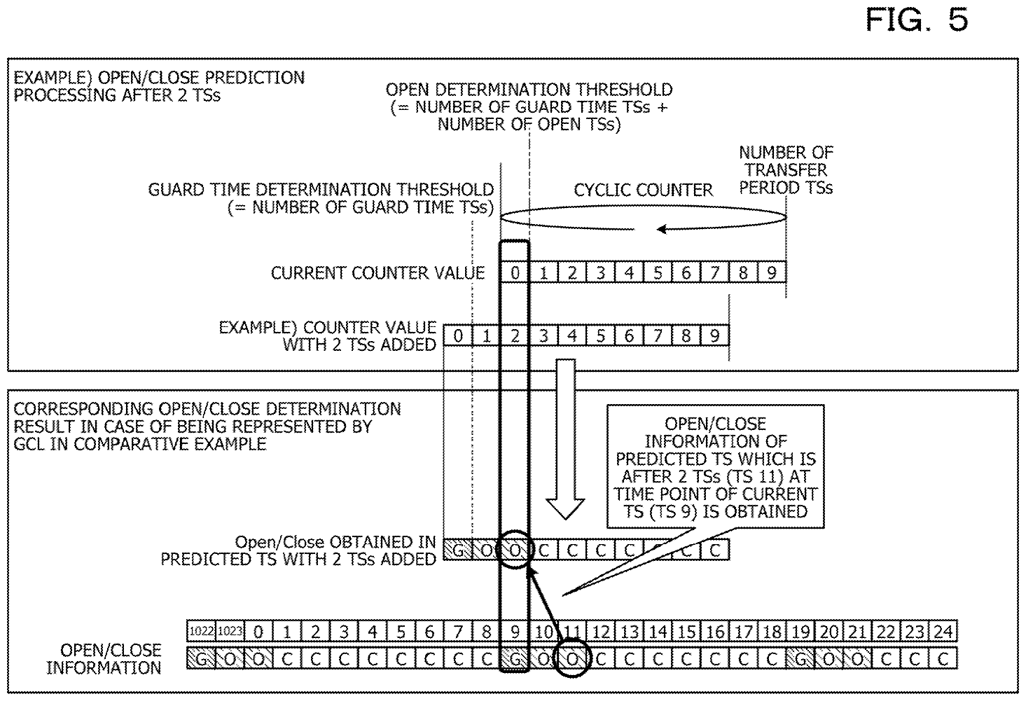

FIG. 5 is an explanatory diagram illustrating an example of a processing operation of the packet processor 12 related to open/close prediction processing. Based on the number of transfer period TSs, the number of guard time TSs, the number of open TSs, and the number of transfer period offset TSs of the corresponding class, the second decision unit 33 calculates and decides the open/close information of the gate 22 corresponding to the corresponding class in the predicted TS from the counter value after N seconds, which is N seconds after the current counter value.

The second decision unit 33 counts up the current counter value for each TS pulse from the time counter 26A, and the number of predicted TSs, which is (the current counter value+N seconds), is circulated once in the number of transfer period TSs.

In a case where the number of predicted TSs the number of guard time TSs, the second decision unit 33 determines the gate determination result of the predicted TS as the guard time. In a case where the number of guard time TSs<the number of predicted TSs (the number of guard time TSs+the number of open TSs), the second decision unit 33 determines that the gate determination result of the predicted TS is open. In a case where (the number of guard time TSs+the number of open TSs)<the number of predicted TSs, the second decision unit 33 determines that the gate determination result of the predicted TS is close. Each second decision unit 33 determines the open/close information of the predicted TS of each class. As illustrated in FIG. 5, the open/close information of the predicted TS after N seconds, for example, after 2 TSs is calculated.

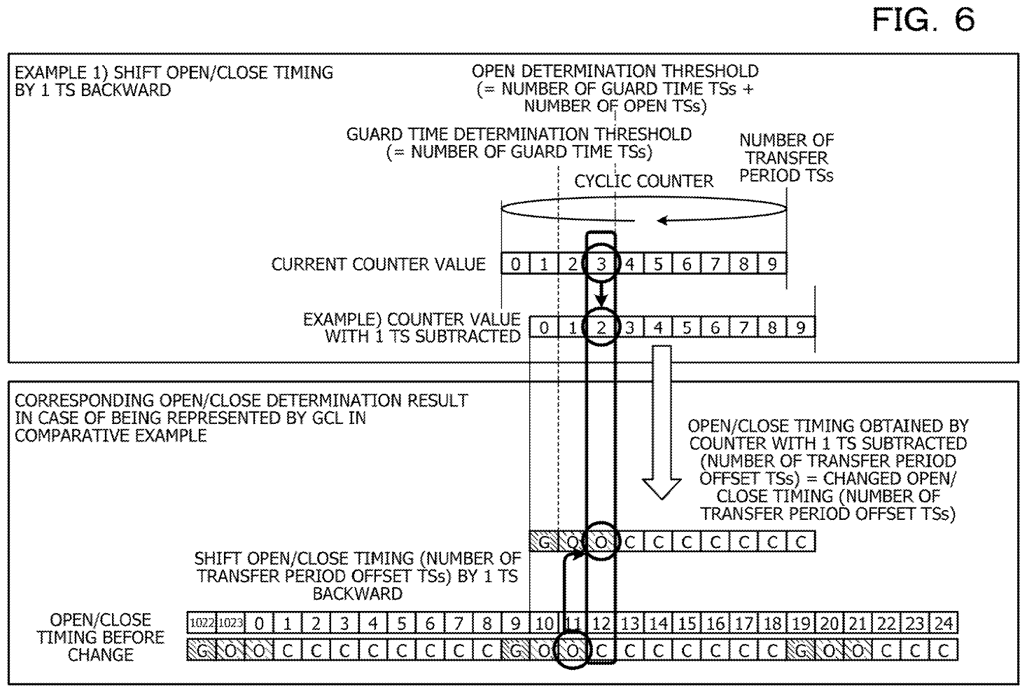

FIG. 6 is an explanatory diagram illustrating an example of a processing operation of the packet processor 12 related to arbitration processing. When the timing conflict between the classes is detected in the open/close information of the predicted TS after N seconds for each class, the arbitration unit 34 changes an operation parameter for avoiding the timing conflict between the classes based on the priority order for each class, which is the arbitration policy. The arbitration unit 34 updates the changed operation parameter in the prediction operation memory 36.

The arbitration control unit 34B in the arbitration unit 34 changes the number of transfer period offset TSs of the conflict class to avoid the timing conflict between the classes based on the priority order for each class when the timing conflict between the classes is detected from the open/close information for each class in the predicted TS. For example, in a case where the arbitration control unit 34B avoids the conflict timing by shifting the timing of the open/close information of the conflict class in a backward direction by 1 TS, in the conflict class, the arbitration control unit 34B subtracts+1 from the number of transfer period offset TSs. By contrast, in a case where the arbitration control unit 34B avoids the conflict timing by shifting the timing of the open/close information of the conflict class in a forward direction by 1 TS, in the conflict class, the arbitration control unit 34B adds+1 to the number of transfer period offset TSs.

The arbitration control unit 34B updates the changed number of transfer period offset TSs and the reflection time (M seconds) in the prediction operation memory 36. Further, in a case where the current counter value is the reflection time, the arbitration control unit 34B updates the changed number of transfer period offset TSs of the class, which is updated in the prediction operation memory 36, as the number of transfer period offset TSs in the current operation parameter of the corresponding class in the current operation memory 35. For each reception timing after the changed operation parameter is set, the first decision unit 31 calculates and decides open/close information of a new current TS at the current time point by using the changed current operation parameter in the current operation memory 35.

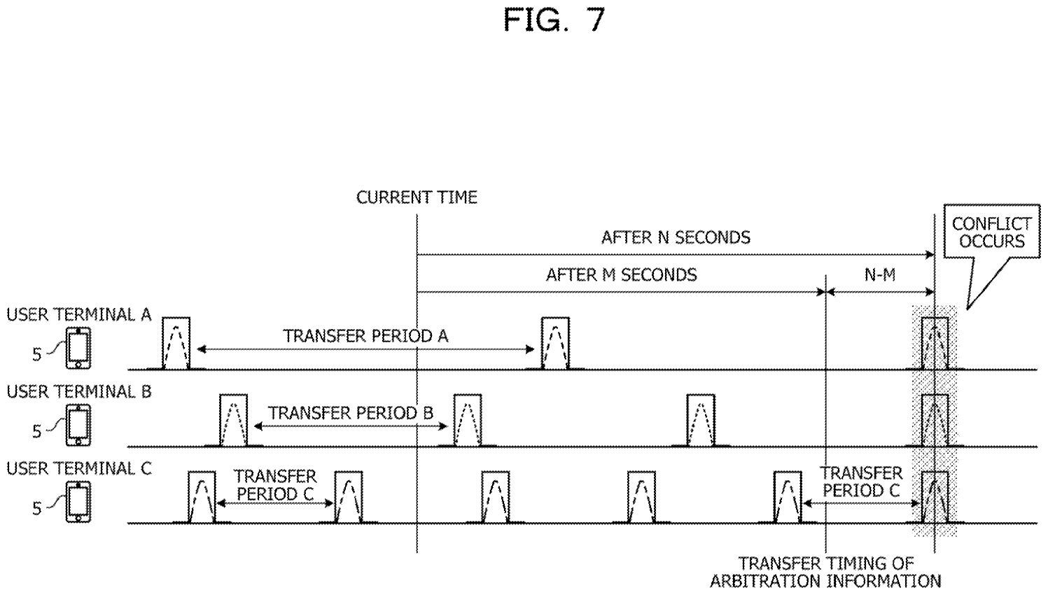

FIG. 7 is an explanatory diagram illustrating an example of a transfer timing of the arbitration information. For example, a case is assumed in which a transfer period of the MFH packet of the service A of the user terminal 5 of “A”, a transfer period of the MFH packet of the service B of the user terminal 5 of “B”, and a transfer period of the MFH packet of the service C of the user terminal 5 of “C” conflict with each other. The arbitration unit 34 is coupled to each iTAS apparatus 6 in the communication system 1, and transfers arbitration information that is an arbitration result to each iTAS apparatus 6. The arbitration information is information including an operation parameter including the changed number of transfer period offset TSs of the conflict class. The arbitration unit 34 transfers the arbitration information to each iTAS apparatus 6 at the transfer timing after M seconds between a timing at which output timings conflict with each other and an output timing immediately before the timing at which the output timings conflict with each other.

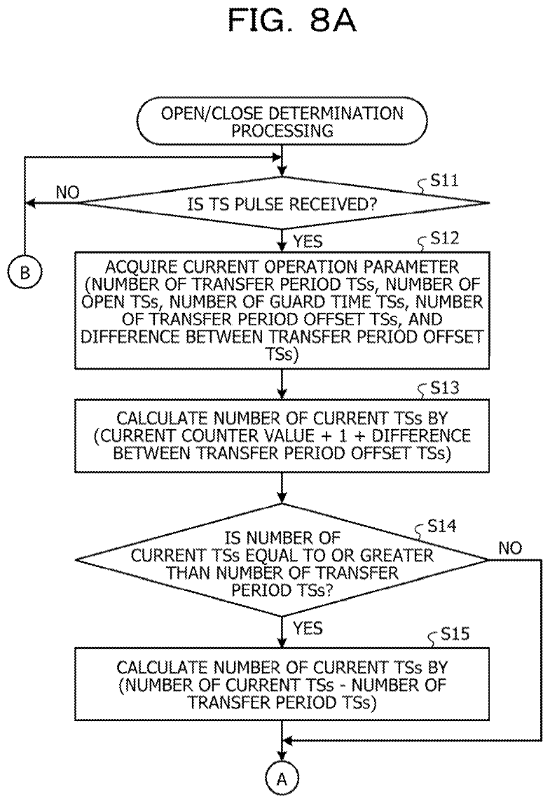

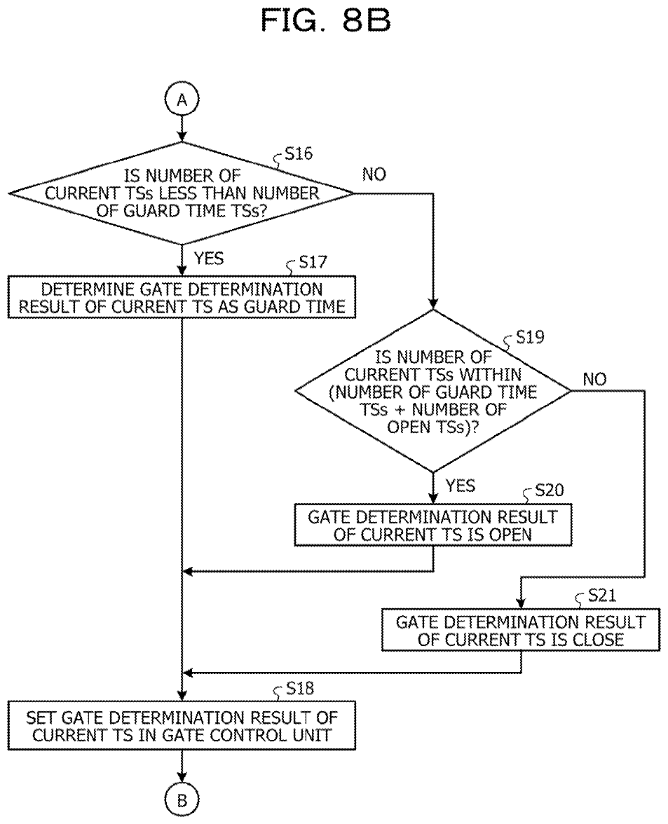

An operation performed by the iTAS apparatus 6 according to the present embodiment will be described next. FIGS. 8A and 8B are a flowchart illustrating an example of a processing operation of the first decision unit 31 related to the open/close determination processing. In FIGS. 8A and 8B, the first decision unit 31 determines whether the TS pulses are received at predetermined intervals from the time counter 26A in the TS management unit 26 (step S11). When the TS pulse is received (step S11: Yes), the first decision unit 31 acquires the current operation parameter from the current operation memory 35 (step S12). The operation parameter includes the number of transfer period TSs, the number of open TSs, the number of guard time TSs, the number of transfer period offset TSs, and a difference between the transfer period offset TSs of the corresponding class of the MFH packet.

The first decision unit 31 calculates the number of current TSs by (the current counter value+1+the difference between the transfer period offset TSs) (step S13). The first decision unit 31 determines whether the number of current TSs is equal to or greater than the number of transfer period TSs for each class (step S14).

When the number of current TSs is equal to or greater than the number of transfer period TSs (step S14: Yes), the first decision unit 31 calculates the number of current TSs by (the number of current TSs−the number of transfer period TSs) (step S15). The first decision unit 31 determines whether the number of current TSs is less than the number of guard time TSs (step S16).

When the number of current TSs is less than the number of guard time TSs (step S16: Yes), the first decision unit 31 determines the gate determination result of the current TS as the guard time (step S17). The first decision unit 31 sets the gate determination result of the current TS in the gate control unit 32 (step S18), and returns to the processing of step S11 in order to determine whether the TS pulse is received. As a result, the gate control unit 32 controls the opening and closing of each gate 22 based on the gate determination result of the current TS.

When the number of current TSs is not less than the number of guard time TSs (step S16: No), the first decision unit 31 determines whether the number of current TSs is within (the number of guard time TSs+the number of open TSs) (step S19). When the number of current TSs is within (the number of guard time TSs+the number of open TSs) (step S19: Yes), the first decision unit 31 determines that the gate determination result of the current TS is open (step S20). The first decision unit 31 returns to the processing in step S18 in order to set the gate determination result of the current TS in the gate control unit 32.

When the number of current TSs is not within (the number of guard time TSs+the number of open TSs) (step S19: No), the first decision unit 31 determines that the gate determination result of the current TS is close (step S21). The first decision unit 31 returns to the processing in step S18 in order to set the gate determination result of the current TS in the gate control unit 32.

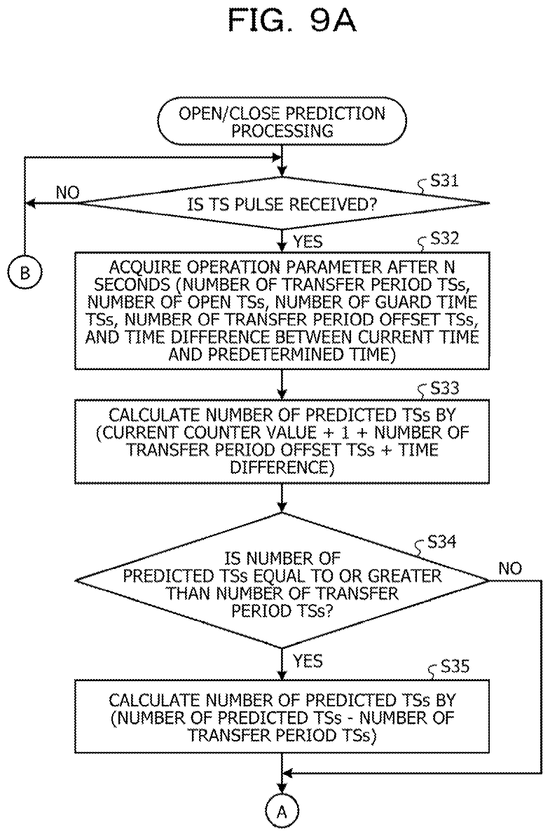

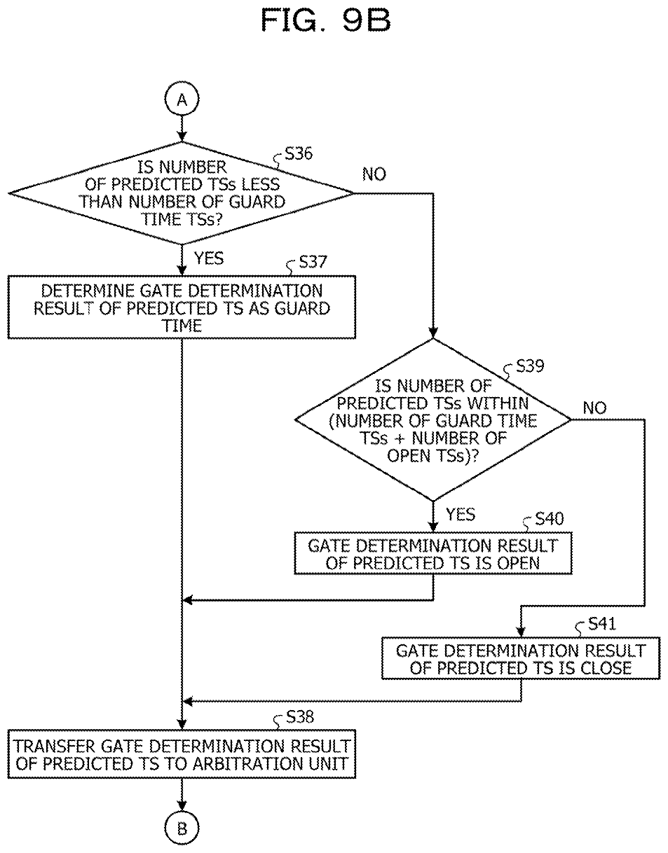

FIGS. 9A and 9B are a flowchart illustrating an example of a processing operation of the second decision unit 33 related to the open/close prediction processing. In FIGS. 9A and 9B, the second decision unit 33 determines whether the TS pulse is received from the time counter 26A in the TS management unit 26 (step S31). In a case where the TS pulse is received (step S31: Yes), the second decision unit 33 acquires an operation parameter from the current operation memory 35 (step S32).

By using (current counter value+1+the number of transfer period offset TSs+time difference (N seconds)), the second decision unit 33 calculates the number of predicted TSs after N seconds from the current time (step S33). The second decision unit 33 determines whether the number of predicted TSs is equal to or greater than the number of transfer period TSs for each class (step S34).

When the number of predicted TSs is equal to or greater than the number of transfer periods TS (step S34: Yes), the second decision unit 33 calculates the number of predicted TSs by (the number of predicted TSs−the number of transfer period TSs) (step S35). The second decision unit 33 determines whether the number of predicted TSs is less than the number of guard time TSs (step S36).

When the number of predicted TSs is less than the number of guard time TSs (step S36: Yes), the second decision unit 33 determines that the gate determination result of the predicted TS is the guard time (step S37). Further, the second decision unit 33 transfers the gate determination result of the predicted TS to the arbitration unit 34 (step S38), and returns to the processing in step S31 in order to determine whether the TS pulse is received.

When the number of predicted TSs is not less than the number of guard time TSs (step S36: No), the second decision unit 33 determines whether the number of predicted TSs is within (the number of guard time TSs+the number of open TSs) (step S39). When the number of predicted TSs is within (the number of guard time TSs+the number of open TSs) (step S39: Yes), the second decision unit 33 determines that the gate determination result of the predicted TS is open (step S40). The second decision unit 33 returns to the processing in step S38 in order to transfer the gate determination result of the predicted TS to the arbitration unit 34.

When the number of predicted TSs is not within (the number of guard time TSs+the number of open TSs) (step S39: No), the second decision unit 33 determines that the gate determination result of the predicted TS is close (step S41). The second decision unit 33 returns to the processing in step S38 in order to transfer the gate determination result of the predicted TS to the arbitration unit 34.

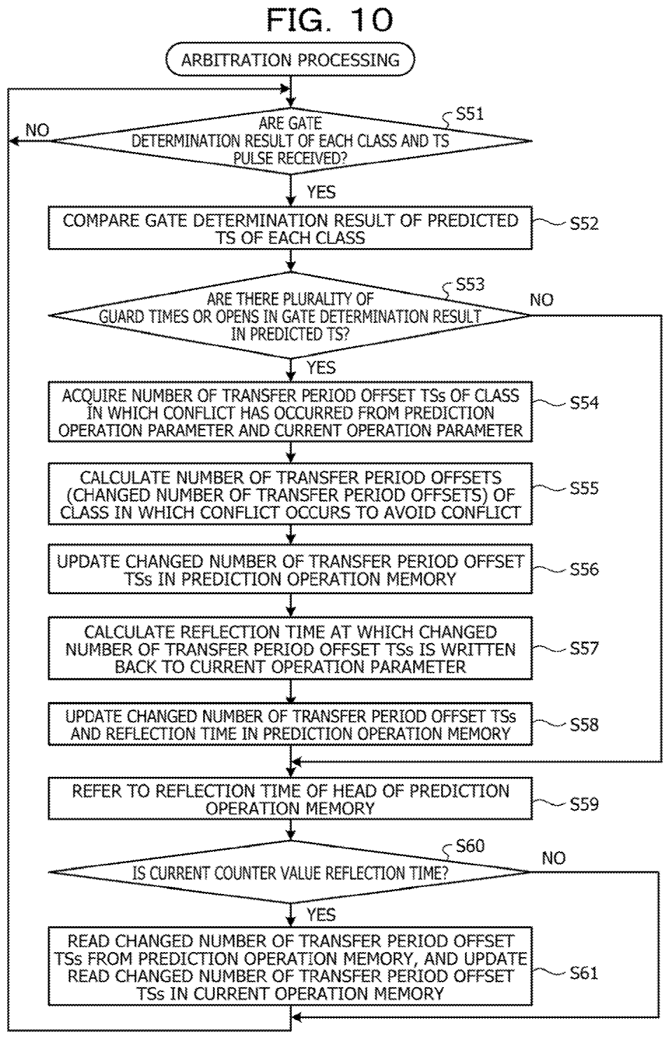

FIG. 10 is a flowchart illustrating an example of a processing operation of the arbitration unit 34 related to the arbitration processing. In FIG. 10, the arbitration unit 34 determines whether the gate determination result of the predicted TS of each class and the TS pulse from the time counter 26A are received from the second decision unit 33 (step S51). The detection unit 34A in the arbitration unit 34 compares the gate determination result of the predicted TS of (current counter value+1) for each class in a case where the gate determination result of the predicted TS of each class and the TS pulse are received (step S51: Yes) (step S52).

The detection unit 34A determines whether there are a plurality of guard times or opens in the gate determination result of the predicted TS (step S53). When there are a plurality of guard times or opens in the gate determination result of the predicted TS (step S53: Yes), the detection unit 34A detects a timing conflict between the classes in the predicted TS.

Further, in a case where the timing conflict between the classes in the predicted TS is detected, the arbitration control unit 34B in the arbitration unit 34 acquires the number of transfer period offset TSs of the class in which the conflict occurs from the current operation parameter (step S54). Based on the arbitration policy (priority order) of each class in which a conflict occurs, the arbitration control unit 34B calculates the number of transfer period offset TSs of each class in which a conflict occurs as the changed number of transfer period offset TSs (step S55).

The arbitration control unit 34B updates the calculated changed number of transfer period offset TSs of each class in the prediction operation memory 36 as a prediction operation parameter (step S56). The arbitration control unit 34B calculates a reflection time of a timing at which the changed number of transfer period offset TSs of each class is reflected to a current operation parameter (step S57).

The arbitration control unit 34B updates the changed number of transfer period offset TSs of each class and the reflection time in the prediction operation memory 36 (step S58). The arbitration control unit 34B refers to the reflection time of a head in the prediction operation memory 36 (step S59), and determines whether a current counter value is the reflection time (step S60). When the current counter value is the reflection time (step S60: Yes), the arbitration control unit 34B reads the changed number of transfer period offset TSs of the head from the prediction operation memory 36. Further, the arbitration control unit 34B updates the read changed number of transfer period offset TSs in the current operation memory 35 as a current operation parameter (step S61). The arbitration control unit 34B returns to the processing in step S51 in order to determine whether the gate determination result of each class and the TS pulse are received.

When the gate determination result of each class and the TS pulse are not received (step S51: No), the detection unit 34A returns to the processing of step S51. When there are not a plurality of guard times or opens in the predicted TS (step S53: No), the detection unit 34A determines that the conflict timing between the classes in the predicted TS has not occurred. In a case where the timing conflict between the classes in the predicted TS is not detected, the detection unit 34A returns to the processing in step S51 in order to determine whether the gate determination result of each class and the TS pulse are received.

When the current counter value is not the reflection time (step S60: No), the arbitration control unit 34B returns to the processing in step S51 in order to determine whether the gate determination result of each class and the TS pulse are received.

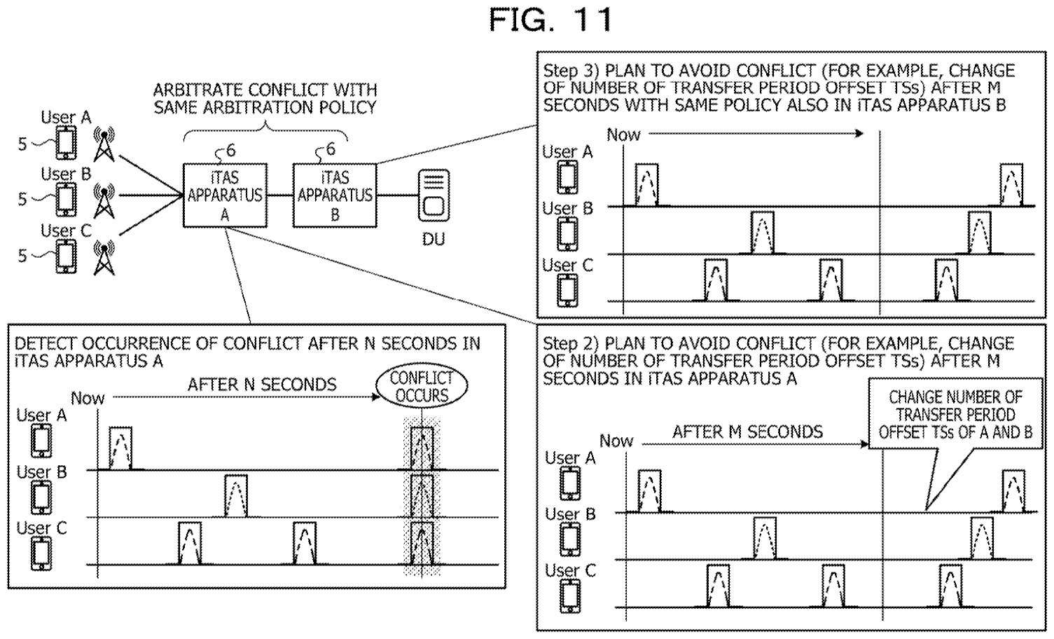

FIG. 11 is an explanatory diagram illustrating an example of a processing operation of the communication system 1 related to the arbitration processing. It is assumed that the user terminal 5 of “A” outputs the MFH packet of the service A to the DU via the iTAS apparatus 6 of “A” and the iTAS apparatus 6 of “B”, and the user terminal 5 of “B” outputs the MFH packet of the service B to the DU via the iTAS apparatus 6 of “A” and the iTAS apparatus 6 of “B”. Furthermore, it is assumed that the user terminal 5 of “C” outputs the MFH packet of the service C to the DU via the iTAS apparatus 6 of “A” and the iTAS apparatus 6 of “B”.

When the timing conflict of the MFH packets between the services A, B, and C in the predicted TS after N seconds is detected, the iTAS apparatus 6 of “A” changes the number of transfer period offset TSs of each service in order to avoid the conflict of the MFH packets between the services in the predicted TS after N seconds. Further, the iTAS apparatus 6 of “A” reflects the number of transfer period offset TSs of each service at the reflection time after M seconds from the current TS. Further, the iTAS apparatus 6 of “A” transfers the number of transfer period offset TSs of each service reflected at the reflection time after M seconds from the current TS to the iTAS apparatus 6 of “B” as the arbitration information. The iTAS apparatus 6 of “B” reflects the number of transfer period offset TSs of each service in the current operation memory 35 at the reflection time after M seconds from the current TS based on the arbitration information from the iTAS apparatus 6 of “A”. As a result, since the iTAS apparatus 6 of “A” and the iTAS apparatus 6 of “B” share the same current operation parameter, it is possible to suppress the output delay of the MFH packet of each service while avoiding the timing conflict between the services. A delay variation of each of services having different MFH packet transfer periods may be reduced.

By using the current counter value and the operation parameter of each service in the MFH packet, the iTAS apparatus 6 in the present embodiment decides the open/close information of the current TS of each service, and controls the opening/closing of the gate 22 of each service based on the open/close information of the current TS of each service. As a result, the open/close information of each service of the same MFH packet may be recognized by using the operation parameter without using the large-capacity GCL.

Further, the iTAS apparatus 6 decides the open/close information of the predicted TS after N seconds of each service by using (the current counter value+N seconds) and the operation parameter of each service, and determines whether the timing conflict of the MFH packets is detected in the open/close information in the predicted TS after N seconds for each service. When the timing conflict is detected, the iTAS apparatus 6 changes the contents of the operation parameter based on the priority order of the conflicting MFH packet for each service in order to avoid the timing conflict, and updates the changed operation parameter in the current operation memory 35 at the reflection time that is before the timing at which the predicted TS arrives. For each reception timing of the TS pulse after the changed operation parameter is set, the iTAS apparatus 6 decides open/close information of a new current TS at the current time point for each service by using the changed operation parameter updated in the current operation memory 35. As a result, even when the GCL is not used, it is possible to avoid the timing conflict between the services of the same MFH packet by using the operation parameter. Furthermore, a processing load for avoiding the timing conflict may be significantly reduced.

The arbitration unit 34 detects a conflict between the services that occurs in the services having different number of transfer period TSs at a timing after N seconds from the current TS, and arbitrates the number of transfer period offset TSs of the service that is a conflict target. As a result, the timing conflict between the services may be avoided.

The iTAS apparatus 6 decides, for the update of the open/close information due to occurrence of a conflict, the open/close information of the gate 22 for each service from the current counter value and an operation parameter such as the number of transfer period TSs, instead of rewriting the GCL for one period. As a result, only by changing the operation parameter, the open/close information of the service that is a conflict target may be changed in a short time.

Even without using a large-capacity GCL in which the least common multiple of the numbers of transfer period TSs of the services having different transfer periods is set as one period, the iTAS apparatus 6 decides open/close information for each service from a current counter value and an operation parameter such as the number of transfer period TSs. As a result, a plurality of services with an arbitrary number of transfer period TSs may be accommodated with a small resource scale.

The iTAS apparatus 6 detects in advance a timing conflict between services that occurs when the services having different transfer periods are managed, and changes the changed number of transfer period offset TSs in a short period. Further, the iTAS apparatus 6 updates the operation parameter including the changed number of transfer period offset TSs in the current operation memory 35. As a result, the timing conflict between the services may be avoided.

The first decision unit 31 decides open/close information in a current TS by using a current counter value and an operation parameter including the number of transfer period TSs different for each service. Further, the second decision unit 33 decides open/close information in a predicted TS after N seconds from the current time by using the current counter value+N seconds and an operation parameter different for each service. As a result, even when the GCL is not used, the open/close information in the current TS and the predicted TS of each service of the same MFH packet may be recognized by using the operation parameter.

The arbitration unit 34 detects a conflict between an open period and a guard time period of MFH packets between services as a conflict timing between services in the open/close information in a predicted TS. When the conflict is detected, the arbitration unit 34 changes an operation parameter in order to avoid the timing conflict based on a priority order for each service that is a conflict target. As a result, even when the GCL is not used, it is possible to avoid the timing conflict between the services of the MFH packets of the same type by using the operation parameter.

Based on the number of transfer period TSs for each service of the MFH packet, the number of guard time TSs for each service, the number of open TSs for each service, and the number of transfer period offset TSs for each service, the first decision unit 31 decides the open/close information in the current TS from the current counter value. As a result, even when the GCL is not used, the open/close information in the current TS of each service of the MFH packet may be recognized by using the operation parameter.

Based on the number of transfer period TSs for each service of the MFH packet, the number of guard time TSs for each service, the number of open TSs for each service, the number of transfer period offset TSs for each service, and the current counter value+N seconds, the second decision unit 33 decides the open/close information in the predicted TS after N seconds. As a result, even when the GCL is not used, the open/close information in the predicted TS of each service of the MFH packet may be recognized by using the operation parameter.

The arbitration unit 34 is coupled to another iTAS apparatus 6 and transfers the changed operation parameter to the another iTAS apparatus 6 as arbitration information. As a result, the delay variation of each of services having different MFH packet transfer periods may be minimized by sharing the changed operation parameter in each iTAS apparatus 6.

The arbitration unit 34 transfers the changed operation parameter between a timing at which output timings conflict with each other and an output timing of a conflicting MFH packet immediately before the timing at which the output timings conflict with each other to the iTAS apparatus 6 as arbitration information. As a result, it is possible to suppress the output delay of each service while avoiding the timing conflict between the services before the conflict occurs. A delay variation of each of services having different MFH packet transfer periods may be reduced.

According to the comparative example, in a case where the GCL manages the open/close information of 2048 TSs of all the services, in a case where the timing of the open/close information of the service that is a conflict target is corrected by shifting by 1, it is desired to change the open/close information of 2048 bits of the service. Accordingly, the open/close information of 2048 bits is corrected by accessing the GCL a plurality of times.

By contrast, in the present embodiment, even when the open/close information of the service that is a conflict target is changed by shifting by 1 in the forward direction, since the GCL is not used, it is sufficient to subtract 1 TS from the number of transfer period offset TSs of the service that is a conflict target. Furthermore, in order to subtract 1 TS from the number of transfer period offset TSs of the service that is a conflict target, for example, the update of 12 bits is sufficient, so that the change may be performed by one access. Accordingly, in the present embodiment, the processing time taken to avoid the conflict may be significantly reduced as compared with the comparative example.

In the GCL that manages the open/close information of all the services having different transfer periods, since it is desired to manage the open/close information for each service of the number of TSs as the least common multiple of all the services, the capacity increases as the number of services increases. By contrast, in the present embodiment, since the open/close information for the number of transfer period TSs is sufficient for each service, a large-capacity memory is not demanded.

Although it is assumed in the above embodiment that there are two types of MFH packets of high-priority packets and MBH packets of low-priority packets, the packets are not limited to these two types and may be changed as appropriate. Although the case where the classes in the MFH packet are eight classes of C0 to C7 is exemplified, the classes are not limited to the eight classes and may be changed as appropriate.

Although the case where a plurality of classes exist in the MFH packet and the conflict between the output timings of the classes is avoided is exemplified, the embodiment is not limited to the MFH packet but may be applied to a packet in which a plurality of classes exist in packets of the same type.

Although the classes in the services having different MFH packets are exemplified for convenience of description, it is not limited to the classes, and may also be applied to the MFH packets of the user terminal 5 having different bandwidths or transfer periods.

Although the case where the first decision unit 31 and the second decision unit 33 are provided for each class is exemplified in the above embodiment, the single first decision unit 31 may calculate the open/close information of each class of the current TS and the single second decision unit 33 may calculate the open/close information of each class of the predicted TS, which may be changed as appropriate.

Although the analysis unit 28 and the control unit 29 are disposed in the packet processor 12 in the above embodiment, the analysis unit 28 and the control unit 29 may be disposed in the CPU 15, for example, and may be changed as appropriate.

Although one period of a subframe is set to, for example, N TSs in the above embodiment, one period of a subframe may be set to a multiple of N as long as periodicity may be maintained, and may be changed as appropriate.

As for the control unit 29 in the packet processor 12, the case where the first decision unit 31, the gate control unit 32, the second decision unit 33, and the arbitration unit 34 are configured by hardware is exemplified. However, each function of the first decision unit 31, the gate control unit 32, the second decision unit 33, and the arbitration unit 34 may be executed by a program, and may be changed as appropriate.

The constituent elements of the respective units illustrated in the drawings do not necessarily have to be physically configured as illustrated. For example, specific configurations of dispersion and integration of the respective units are not limited to those illustrated in the drawings, and all or some of the elements may be configured in a functionally or physically dispersed and integrated manner in an arbitrary unit depending on various loads, usage, and the like.

As for the various processing functions executed in each device, all or an arbitrary part thereof may be executed over a central processing unit (CPU) (or a microcomputer such as a microprocessor unit (MPU) or a microcontroller unit (MCU)). It goes without saying that, all or an arbitrary part of the various processing functions may be executed over a program for analysis and execution using the CPU (or microcomputer such as the MPU or MCU) or over wired logic hardware.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A packet processing apparatus comprising:
a gate provided for each service and configured to open and close an output of a packet in a unit of a time slot; and
a processor coupled to the gate and configured to:
decide open/close information of a corresponding gate in a first time slot at a current time point by using a set operation parameter, for each reception timing of the time slot, for each of the services;
control opening and closing of each gate based on the open/close information in the first time slot at the current time point for each of the services;
decide open/close information of the corresponding gate in a second time slot after a predetermined timing from the current time point by using the operation parameter for each of the reception timings, for each of the services;
detect a timing conflict between the services in the open/close information in the second time slot after the predetermined timing for each of the services;
in a case where the timing conflict is detected, change contents of the operation parameter set to avoid the timing conflict between the services based on a priority order for each of the services;
reset the changed operation parameter before the predetermined timing arrives; and
decide open/close information in a new first time slot at the current time point by using the set changed operation parameter for each of the reception timings after the changed operation parameter is set, for each of the services.

2. The packet processing apparatus according to claim 1, further comprising:
a counter configured to count a current counter value,
wherein the processor
decides the open/close information in the first time slot at the current time point by using the current counter value and the operation parameter including a period for observing the packet of the service, for each of the services, and
decides the open/close information in the second time slot after the predetermined timing from the current time point by using a counter value after a predetermined timing from the current counter value and the operation parameter, for each of the services.

3. The packet processing apparatus according to claim 1,
wherein the processor
detects a timing conflict between an output period of a packet and a guard time period between the services as the timing conflict between the services in the open/close information in the second time slot after the predetermined timing.

4. The packet processing apparatus according to claim 1,
wherein the processor
detects a timing conflict between output periods of packets between the services as the timing conflict between the services in the open/close information in the second time slot after the predetermined timing.

5. The packet processing apparatus according to claim 2,
wherein the operation parameter
includes a number of transfer period time slots which is a transfer period of the packet for each of the services, a number of guard time slots indicative of a guard time period of the packet for each of the services among the number of transfer period time slots, a number of open time slots indicative of an open period of a gate for each of the services among the number of transfer period time slots, and a number of transfer period offset time slots indicative of a slot number for starting an output of the packet for each of the services among the number of transfer period time slots.

6. The packet processing apparatus according to claim 5,
wherein the processor
changes the number of transfer period offset time slots in the operation parameter to avoid a timing conflict between the services.

7. The packet processing apparatus according to claim 1,
wherein mobile front haul (MFH) packets having different types of services transmitted in an MFH line are output as the packets.

8. The packet processing apparatus according to claim 5,
wherein the processor
decides the open/close information in the first time slot at the current time point from the current counter value based on the number of transfer period time slots for each of the services, the number of guard time slots for each of the services, the number of open time slots for each of the services, and the number of transfer period offset time slots for each of the services, for each of the services, and
decides the open/close information in the second time slot after the predetermined timing from the current counter value, based on the number of transfer period time slots for each of the services, the number of guard time slots for each of the services, the number of open time slots for each of the services, and the number of transfer period offset time slots for each of the services, for each of the services.

9. The packet processing apparatus according to claim 1,
wherein the processor
is coupled to another packet processing apparatus and transfers the changed operation parameter to the another packet processing apparatus.

10. The packet processing apparatus according to claim 9,
wherein the processor
transfers the changed operation parameter between a timing at which the services conflict with each other and an output timing of the conflicting packet immediately before the timing at which the services conflict with each other to the another packet processing apparatus.

11. A packet processing method comprising:
deciding open/close information of a corresponding gate, which is provided for each service and is configured to open and close an output of a packet in a unit of a time slot, in a first time slot at a current time point by using a set operation parameter, for each reception timing of the time slot, for each of the services;
controlling opening and closing of each gate based on the open/close information in the first time slot at the current time point for each of the services;
deciding open/close information of the corresponding gate in a second time slot after a predetermined timing from the current time point by using the operation parameter for each of the reception timings, for each of the services;
detecting a timing conflict between the services in the open/close information in the second time slot after the predetermined timing for each of the services;
in a case where the timing conflict is detected, changing contents of the operation parameter set to avoid the timing conflict between the services based on a priority order for each of the services, and reset the changed operation parameter before the predetermined timing arrives; and
deciding open/close information in a new first time slot at the current time point by using the set changed operation parameter for each of the reception timings after the changed operation parameter is set, for each of the services.
